(19) United States
(12) Patent Application Publication
(10) Pub. No.: US 2004/0230538 A1
(43) Pub. Date: Nov. 18, 2004

(54) Identity theft reduction system

(76) Inventors: John William Clifton, Marshall, MI (US); Paul Frank Guagliardo, Arlington Heights, IL (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/437,652

(22) Filed: May 13, 2003

(51) Int. Cl. G06F 17/60

(52) U.S. Cl. 705/72

(57) ABSTRACT

An identity theft reduction system for reducing identity theft includes a client computer system and a service provider computer system. The service provider computer system is in communication with the client computer system and executes code for causing the service provider computer system to perform a number of steps. An employee of a financial institution, utilizing the client computer system, furnishes a personal identification number (PIN) and an associated social security number (SSN) of an individual along with a valid institutional code and an associated valid employee code to register the PIN and associated SSN. A credit report is provided to a requester when a supplied PIN and SSN correspond to a registered PIN and SSN.

### BACKGROUND OF THE INVENTION

The present invention is generally directed to a theft reduction system and, more specifically, to an identity theft reduction system.

It is common practice for a creditor to request a credit report for an individual before extending credit to that individual. In a typical situation, a creditor requests a social security number (SSN) of the individual, at which point the creditor requests a credit report from one of any number of credit bureaus, e.g., consumer reporting agencies, such as Equifax™, Experian™ and TransUnion™. Upon receiving the credit report from a credit bureau, the creditor may then use the credit information contained in the credit report in determining whether to approve/disapprove entering into a financial transaction, for example, a loan, a rental agreement, a real estate agreement, etc., with the individual. However, when the individual seeking credit has assumed another individual's identity, the creditor may erroneously extend credit to the individual. This type of fraud may cost creditors hundreds of millions of dollars every year and can cause the individual whose identity has been stolen difficulty in obtaining future credit due to the fraud perpetuated upon the individual's identity.

A number of systems have been proposed and/or implemented to prevent unauthorized access to various consumer information. For example, U.S. Patent Application Publication No. 2003/0009435 discloses a centralized personal database that is accessible via the Internet and secured by a combination of identification numbers, including a basic, a primary and a secondary number. The secure personal database is accessible to a customer using a combination of the basic and primary numbers and is accessible to others who have been supplied with the basic number and a secondary number. In general, the primary and secondary numbers may be thought of as personal identification numbers (PINs).

As another example, U.S. Patent Application Publication No. 2002/0174067 discloses a tokenless electronic transaction system that uses a biometric sample of a buyer and an associated PIN to validate a buyer with a seller. As is disclosed, upon the determination of sufficient resources in a buyer's financial account, the financial account of the buyer is debited and a financial account of the seller is credited. The buyer initially registers with the system by providing at least one biometric sample and a PIN along with a financial account number. The seller registers with the system by providing a seller financial account number. In performing a registration operation, an employee identifies himself/herself using a biometric sample and PIN when initially activating the registration system.

U.S. Patent Application Publication No. 2002/0143708 discloses a system for conducting secure credit card transactions over the Internet that prompts a consumer to enter a pre-registered PIN which, together with a phone number from which the consumer is calling, is used to verify the identity of the consumer. The system implements software that selectively switches a consumer's computer connection from a merchant's web site on the Internet to a secured telephone line for accessing a free standing server used to obtain authorization to make a purchase and then switches the consumer back to the merchant's web site once such authorization is obtained or denied. As is disclosed, a consumer may provide their social security number (SSN) for identification purposes.

U.S. Pat. No. 5,892,900 discloses a system that provides secure transaction management so as to maintain integrity, availability and/or confidentiality of information and processes related to the use of the information. The system tracks an individual's credit and generally protects the security of information related to the individual. The system also alternatively provides one or more passwords or other information used to identify or otherwise verify/authenticate an individual's identity. While the above-described systems attempt to limit the dissemination of an individual's personal information, these systems may fail to adequately safeguard the ability of one individual to assume the identity of another individual when seeking credit.

What is needed is a system that reduces personal identity theft by insuring that an individual who has applied for credit is legitimate before providing a potential creditor with a credit report on the individual.

### SUMMARY OF THE INVENTION

One embodiment of the present invention is directed to an identity theft reduction system for reducing identity theft that includes a client computer system and a service provider computer system. The service provider computer is in communication with the client computer system and executes code for causing the service provider computer system to perform a number of steps. Initially, a different institutional identification code is assigned to a plurality of authorized institutions. Next, a different employee code is assigned to at least one employee of each of the authorized institutions. Then, an employee of the financial institution, utilizing the client computer system, furnishes an assigned PIN and an associated SSN of an individual along with a valid institutional code and an associated valid employee code to register the SSN and the assigned PIN. Finally, a credit report is provided to a requestor when a supplied PIN and SSN correspond to a registered PIN and SSN.

According to another embodiment of the present invention, the service provider computer system executes additional code for causing the service provider computer system to verify that a password associated with the employee is valid before registering the PIN and associated SSN.

According to yet another embodiment of the present invention, the service provider computer system executes additional code for causing the service provider computer system to monitor associated credit report requests and flagging at least one of the employee, the institution or the individual when the associated credit report requests are above a predetermined level during a predetermined time period. The system then notifies at least one of the institution and the individual of a potential identity theft when the associated credit report requests are above the predetermined level during the predetermined time period.

These and other features, advantages and objects of the present invention will be further understood and appreciated by those skilled in the art by reference to the following specification, claims and appended drawings.

### BRIEF DESCRIPTION OF THE DRAWINGS

FIG. 1 is an electrical block diagram of an exemplary private secured computer network;

FIG. 2 is an electrical block diagram of an exemplary computer network that utilizes the Internet;

FIG. 3 is a flow-chart of an exemplary institution set-up routine;

FIG. 4 is a flow-chart of an exemplary credit bureau routine; and

FIG. 5 is a flow-chart of an exemplary credit report request routine.

### DETAILED DESCRIPTION OF PREFERRED EMBODIMENTS

As is described further herein, an identity theft reduction system designed according to the present invention reduces and/or eliminates personal identity theft by ensuring that an individual that applies for credit is, in fact, the individual who they represent themselves to be. According to one embodiment of the present invention, the identity theft reduction system is linked with a number of credit bureau computer systems and financial institution computer systems so as to allow an individual with a social security number (SSN) to assign a personal identification number (PIN), e.g., a 4 to 10 digit numeric or alphanumeric string, to their SSN. According to the present invention, the credit bureau does not provide a credit report to a creditor unless the individual produces a valid PIN with the SSN.

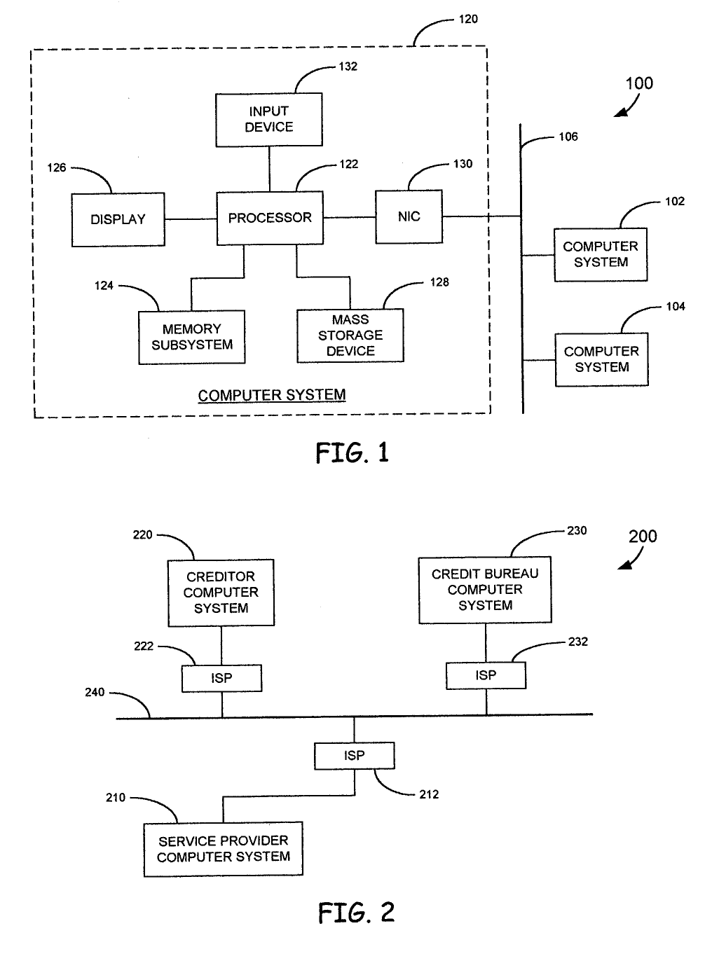

FIG. 1 depicts an exemplary computer network 100 that includes three computer systems 102, 104 and 120, which are coupled to a private secured communication link 106. The computer system 120, which is exemplary of the computer systems 102 and 104, includes a processor 122 that is coupled to a mass storage device 128, a memory subsystem 124, a display 126, an input device 132 and a network interface card (NIC) 130. The memory subsystem 124 includes an application appropriate amount of volatile and non-volatile memory and the mass storage device 128 is utilized to store one or more databases that may be utilized by the service provider computer system 120, which is programmed according to the present invention.

FIG. 2 depicts an exemplary computer network 200 that includes computer systems 210, 220 and 230 that are capable of communicating with each other over an Internet connection 240, via Internet service providers (ISPs) 212, 222 and 232, respectively. As an example, when an individual approaches an authorized financial institution to set-up an account with the identity theft reduction system, an employee of the creditor, utilizing the computer system 220, communicates with the service provider computer system 210, via the Internet 240 and the ISPs 212 and 222. According to one embodiment of the present invention, the identity theft reduction service may be offered to a qualified financial institution that meets minimum requirements for proof of identity. In this manner, an authorized financial institution can offer the identity theft reduction service to any of its customers.

According to this embodiment, an employee of the qualified financial institution, such as a loan officer or interviewer, provides customer registration information to the service provider for each customer. This information can be provided in various ways, such as through a paper or electronic form. In one embodiment, the form would require an institution identification number, an employee code, the individual's SSN and a PIN. The PIN may be selected by the customer and may be of varying lengths. The form is then electronically provided to the service provider computer system 210 through a secured interface. According to another embodiment of the present invention, the employee may provide the information via a voice interface. It should be appreciated that the employee of an authorized financial institution may verify the identity of a customer through examination of at least one of a driver's license, a passport, a SSN card, a credit card, and a birth certificate, or other identification means.

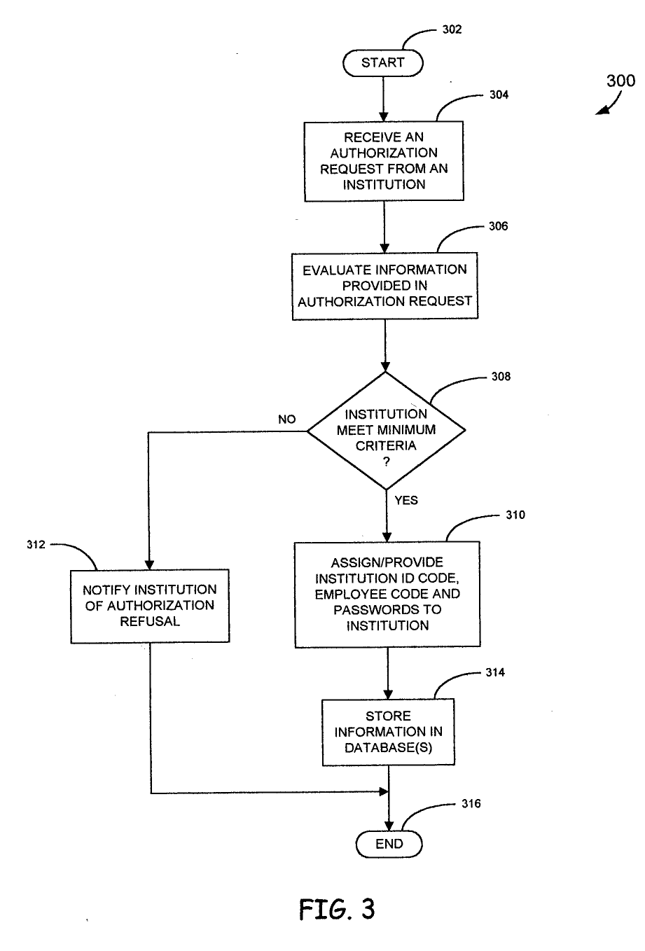

An exemplary institution set-up routine 300 is further depicted in FIG. 3. In step 302, the routine 300 is initiated, at which point control transfers to step 304, where the computer system 210 receives an authorization request from an institution, via, for example, the computer system 220. Next, in step 306, the system 210 evaluates the information provided in the authorization request to determine whether the institution meets the minimum criteria to become a qualified financial institution. Then, in decision step 308, the system 210 determines whether the institution has met the minimum criteria and, if so, control transfers to step 310.

If the financial institution does not meet the minimum criteria in step 308, control transfers to step 312, where a communication is sent to the financial institution notifying the institution of authorization refusal, at which point control transfers to step 316, where the routine 300 terminates. In step 310, after establishing that the institution meets the minimum criteria in step 308, the system 210 assigns institution identification codes, employee codes and passwords to the institution and communicates the information to the financial institution. Next, in step 314, the system 210 stores the information in one or more databases before the routine 300 terminates in step 316.

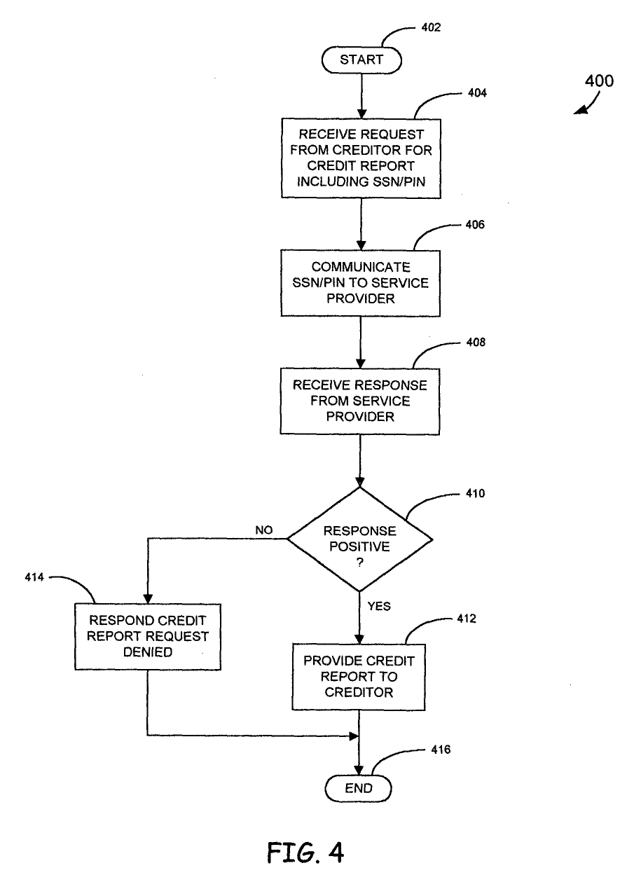

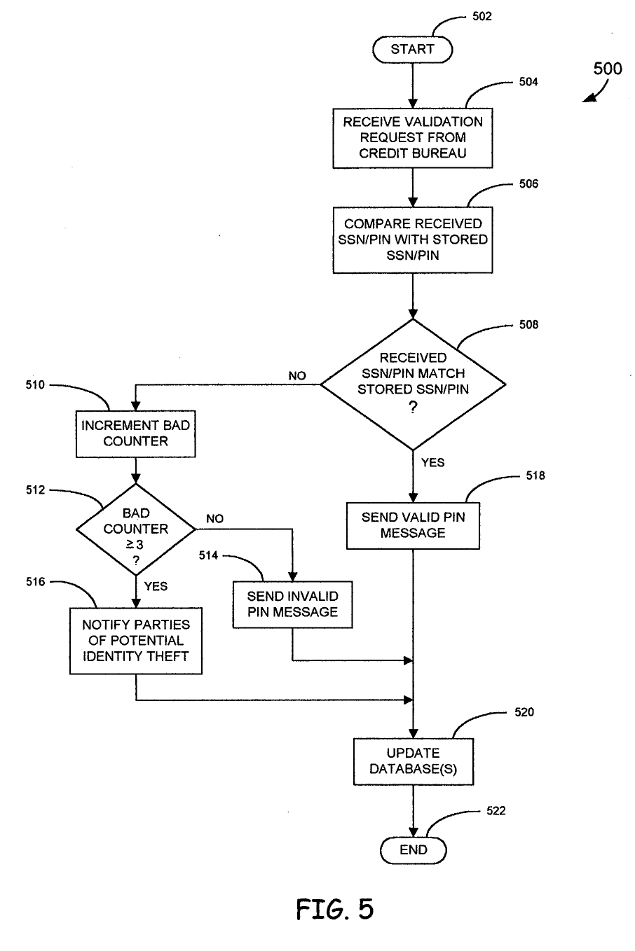

With reference to FIG. 4, a credit bureau routine 400 is further depicted. The routine 400 is designed to be executed on a credit bureau computer system, e.g., the computer system 230, which is coupled to Internet 240 through the ISP 232. In step 402, the routine 400 is initiated, at which point control transfers to step 404, where the computer system 230 receives a request that includes a combination SSN and PIN from, for example, the creditor computer system 220. Next, in step 406, the computer system 230 communicates the SSN/PIN to the service provider computer system 210 via, for example, a secured Internet connection. Then, in step 408, the computer system 230 receives a response from the service provider computer system 210.

Next, in decision step 410, the computer system 230 determines whether the response was a positive response. If the response was a positive response, control transfers from step 410 to step 414. If the response is not a positive response, control transfers from step 410 to step 414, where the computer system 230 provides a message to the computer system 220, indicating that the credit report requested is denied, at which point control transfers to step 416, where the routine 400 terminates. In step 410, when a positive response is received, control transfers to step 412, where the computer system 230 causes a credit report to be provided to the creditor. This may be achieved by causing a report for the individual to be printed and mailed to the creditor and/or an electronic transfer of the credit report may take place. In step 412, control transfers to step 416, where the routine 400 terminates.

With reference to FIG. 5, an exemplary credit report request routine 500 is shown. The routine 500 is initiated in step 502, at which point control transfers to step 504, where the computer system 210 receives a validation request from the credit bureau computer system 230. Next, in step 506, the computer system 210 compares the received SSN/PIN with a stored SSN/PIN to determine if a match occurs. It should be appreciated that the database that contains the stored SSN/PIN pairs may be encrypted. Then, in decision step 508, the computer system 210 determines whether the received SSN/PIN matches a stored SSN/PIN. If so, control transfers from step 508 to step 518, where the computer system 210 sends a valid PIN message to the credit bureau computer system 230. Next, in step 520, the computer system 210 updates an appropriate database or databases before the routine 500 terminates in step 522.

In step 508, when the computer system 210 determines that the received SSN/PIN does not match the stored SSN/PIN, control transfers to step 510. In step 510, the computer system 210 causes a counter, e.g., a BAD counter, to be incremented, at which point control transfers to decision step 512. In step 512, the computer system 210 determines whether the BAD counter is greater than or equal to a predetermined value, e.g., 3. If so, control transfers to step 516, where the computer system 210 notifies the parties, e.g., the financial institution, credit bureaus, authorities and the individual whose SSN has been supplied, of a potential identity theft before transferring control to step 520. In step 520, the routine 500 updates an appropriate database or databases before transferring control to step 522.

In step 512, when the BAD counter is less than 3, control transfers to step 514, where the computer system 210 causes an invalid PIN message to be sent to the credit bureau computer system 230, before transferring control to step 520 for updating appropriate databases and termination of the routine in step 522.

It should be appreciated that the communication link between the computer systems 210, 220 and 230 may be achieved through an application program interface (API) via a secured Internet link. Using a static TCP/IP address, a reasonable security level may be achieved. Further, it may desirable that each employee of the credit bureau be provided with an initial log-in ID and password to begin a session with the service provider computer system 210. It should be appreciated that the initial set-up of the individual PINs may be achieved through an audio system, which prompts an employee of a financial institution for a financial institution number, an employee code and a password, as well as an SSN and a PIN for an individual who desires to secure their SSN.

It should also be appreciated that the service provider computer system 210 may implement one or more databases. For example, the computer system 210 may implement an SSN/PIN database, a financial institution database, a credit bureau database and an access history database. The SSN/PIN database may be utilized to store the SSN and PINs for individuals who have signed up for the service. Further identification information, such as name, address, challenge phrase and passcode may also be included in the SSN/PIN database. The financial institution database may include information for qualifying institutions offering the service. In addition, the financial institution database may include identification numbers for each of the institutions along with associated employee codes and passwords that are used to add new PINs. The credit bureau database houses information for participating credit bureaus and the access history database may be utilized to track access to the service provider computer system 210. In this manner, information can be stored that allows for monitoring excessive accesses and notifying individuals or institutions of a potential problem. As is discussed above, upon, for example, a third attempt to obtain a credit report using an SSN and an invalid PIN, the computer system 210 may automatically lock the account and notify affected credit bureaus and financial institutions of a potential identity theft. Further, an individual whose identity is being stolen may also be notified and/or local authorities may be notified that a potential identity theft is in progress. Further, as is described above, a financial institution can readily add a PIN for a customer's SSN through an audio interface system and the financial institution can also request a credit report with the assigned PIN.

The above description is considered that of the preferred embodiments only. Modifications of the invention will occur to those skilled in the art and to those who make or use the invention. Therefore, it is understood that the embodiment(s) shown in the drawings and described above are merely for illustrative purposes and not intended to limit the scope of the invention, which is defined by the following claims as interpreted according to the principles of patent law, including the doctrine of equivalents.

The invention claimed is:

1. A method for reducing identity theft, comprising the steps of:
assigning a different institutional identification code to a plurality of authorized institutions;
assigning a different employee code to at least one employee of each of the authorized institutions;
registering a social security number (SSN) and an assigned personal identification number (PIN) of an individual with a service provider, wherein the employee of the financial institution provides the service provider with the institutional code, the employee code, the assigned PIN and the SSN of the individual, and wherein the service provider registers the SSN and the assigned PIN when the institutional code and the employee code are valid; and
providing a credit report to a requester when a supplied PIN and SSN provided by the requestor corresponds to a registered PIN and SSN.

2. The method of claim 1, wherein the authorized institutions are financial institutions.

3. The method of claim 1, wherein the financial institutions include banks and saving and loan associations.

4. The method of claim 1, wherein the step of registering a social security number (SSN) and an assigned personal identification number (PIN) of an individual with a service provider includes the step of:
verifying an identity of the individual before providing the service provider with the institutional code, the employee code, the assigned PIN and the SSN of the individual.

5. The method of claim 4, wherein the identity of the individual is verified by the employee through examination of at least one of a driver's license, a passport, a SSN card, a credit card, a birth certificate.

6. The method of claim 4, wherein the step of registering a social security number (SSN) and an assigned personal identification number (PIN) of an individual with a service provider includes the additional step of:
providing a password to the service provider, wherein the service provider verifies the password is legitimate before registering the SSN and the assigned PIN.

7. The method of claim 1, further including the step of:
monitoring associated credit report requests; and
flagging at least one of the employee, the institution and the individual when the associated credit report requests are above a predetermined level during a predetermined period; and
notifying at least one of the institution and the individual of a potential identity theft when the associated credit report requests are above the predetermined level during the predetermined period.

8. The method of claim 1, wherein the credit report is provided by a credit bureau.

9. An identity theft reduction system for reducing identity theft, the system comprising:
a client computer system; and
a service provider computer system in communication with the client computer system, the service provider computer system executing code for causing the computer system to perform the steps of:
assigning a different institutional identification code to a plurality of authorized institutions;
assigning a different employee code to at least one employee of each of the authorized institutions;
registering a personal identification number (PIN) and an associated social security number (SSN) of an individual when an employee of an authorized institution utilizing the client computer system furnishes the PIN and the associated SSN of the individual along with a valid institutional code and an associated valid employee code; and
providing a credit report to a requester when a supplied PIN and SSN combination provided by the requester corresponds to a registered PIN and SSN combination.

10. The system of claim 9, wherein the authorized institutions are financial institutions.

11. The system of claim 10, wherein the financial institutions include banks and saving and loan associations.

12. The system of claim 9, wherein the employee verifies an identity of the individual before providing the service provider computer system with the institutional code, the employee code, the PIN and the associated SSN of the individual.

13. The system of claim 12, wherein the identity of the individual is verified by the employee through examination of at least one of a driver's license, a passport, a SSN card, a credit card, and a birth certificate.

14. The system of claim 12, wherein the service provider computer system includes additional code for causing the service provider computer system to perform the steps of:
verifying that a password associated with the employee is valid before registering the PIN and the associated SSN.

15. The system of claim 9, wherein the service provider computer system includes additional code for causing the service provider computer system to perform the steps of:
monitoring associated credit report requests;
flagging at least one of the employee, the institution and the individual when the associated credit report requests are above a predetermined level during a predetermined period; and
notifying at least one of the institution and the individual of a potential identity theft when the associated credit report requests are above the predetermined level during the predetermined period.

16. The system of claim 9, wherein the credit report is provided by a credit bureau when authorized by the service provider computer system.

17. An identity theft reduction system for reducing identity theft, the system comprising:
a client computer system; and
a service provider computer system in communication with the client computer system, the service provider computer system executing code for causing the computer system to perform the steps of:
assigning a different institutional identification code to a plurality of authorized institutions;
assigning a different employee code to at least one employee of each of the authorized institutions;
registering a social security number (SSN) and an assigned personal identification number (PIN) of an individual when an employee of a financial institution utilizing the client computer system furnishes a PIN and an associated SSN of an individual along with a valid institutional code and an associated valid employee code; and
providing a credit report to a requester when a supplied PIN and SSN provided by the requester corresponds to a registered PIN and SSN.

18. The system of claim 17, wherein the authorized institutions are financial institutions.

19. The system of claim 18, wherein the financial institutions include banks and saving and loan associations.

20. The system of claim 17, wherein the employee verifies an identity of the individual before providing the service provider computer system with the institutional code, the employee code, the PIN and associated SSN of the individual.

21. The system of claim 20, wherein the identity of the individual is verified by the employee through examination of at least one of a driver's license, a passport, a SSN card, a credit card, a birth certificate.

22. The system of claim 20, the service provider computer system executing additional code for causing the service provider computer system to perform the steps of:
verifying that a password associated with the employee is valid before registering the PIN and associated SSN.

23. The system of claim 17, the service provider computer system executing additional code for causing the service provider computer system to perform the steps of:
monitoring associated credit report requests;
flagging at least one of the employee, the institution and the individual when the associated credit report requests are above a predetermined level during a predetermined period; and
notifying at least one of the institution and the individual of a potential identity theft when the associated credit report requests are above the predetermined level during the predetermined period.

24. The system of claim 17, wherein the credit report is provided by a credit bureau when authorized by the service provider computer system.
